(19) United States
(12) Patent Application Publication
(10) Pub. No.: US 2016/0300158 A1
(43) Pub. Date: Oct. 13, 2016

(54) Nurturing Virtual Creatures with Augmented reality and artificial intelligence

(71) Applicant: Yoshida Masato, Sapporo (JP)

(72) Inventor: Yoshida Masato, Sapporo (JP)

(21) Appl. No.: 15/162,631

(22) Filed: May 24, 2016

(51) Int. Cl. G06N 99/00; G06T 19/00

(52) U.S. Cl. CPC G06N 99/005; G06T 19/006; G06T 2219/024

(57) ABSTRACT

The system and method which provides for a virtual creature using an artificial intelligence engine and an augmented reality engine. The user provides input data in form of queries to the client device which is processed by the artificial intelligence engine and results are generated and commands are provide to the augmented reality engine which in turn generates a virtual creature of user's to which the user is able to interact and get assistance. The creature is continuously evolved by the artificial intelligence engine to help the user in a better and efficient manner.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

This invention relates to a virtual creature. More specifically, the disclosed invention relates to a system wherein a virtual creature is developed by the use of augmented reality and artificial intelligence.

Virtual creatures have been growing in the market and recent trends have shown that such creatures prove to be very useful in daily life activities for any user. Virtual creatures are being provided with mobile phones. Various virtual creatures like Cortana, Siri and other have proven to be successful. Though, these virtual creatures are not visible to the user and only accept voice commands. A need for effective virtual creatures who can accept command in different ways and make their presence felt to the user through augmented reality and artificial intelligence is felt by the general public. These creatures can provide support different tasks like navigation, information etc.

The invention aims at effectively providing an virtual creature with the help of augmented reality and artificial intelligence.

U.S. Pat. No.—US 20150062168 A1 provides for a method and system for providing augmented reality based directions. This includes receiving a voice input based on verbal cues provided by one or more vehicle occupants in a vehicle. Additionally, the method and system include generating augmented reality graphical elements based on the directives and the association of the directives with the surrounding environment of the vehicle. The method and system further include displaying the augmented reality graphical elements on a heads-up display system of the vehicle. This particular patent provides a virtual creature which can create a beneficial environment for the user but does not uses the beneficial technology of augmented reality for such purposes.

Another U.S. Pat. No. US 20050102098 A1 provides an adaptive navigation system with artificial intelligence. It provides for a vehicle navigation system that is capable of learning user habits/preferences, mistakes in a digital map database, and new roads that may have been added or constructed after release of the digital map database is disclosed. This system uses an artificial intelligence platform to produce beneficial results according to a particular user.

No invention to the knowledge of the inventor has disclosed a system which has features as that of the present invention. No other invention has provided for a system which incorporates user habits and provides for a virtual creature with the help of augmented reality and artificial intelligence. The virtual creatures already available do not effectively take user preferences into account and do not put the technology to effective use.

The limitations and non-effectiveness of the prior art has been overcome by the instant invention as described below.

### BRIEF SUMMARY OF THE INVENTION

The system consists of a client device which is responsible for taking inputs from the user. The Inputs may be received in varied manner ranging from voice input to gesture or manual input through a suitable device. The client device further sends the input to be processed by the system for further use.

A program is provided in this system which either stored on a local storage device or is present online. This program sends the input data to artificial intelligence engine to process the request as per the user request/command. The artificial intelligence engine generates an augmented reality image to the user environment on the basis of the processed data.

The user can also request the system to generate an augmented reality based virtual creature to which the user may communicate and give commands. The artificial intelligence engine produces this augmented reality image interface. The user is also given the option to choose the kind of augmented reality based virtual creature, which may range from a pet, humanoid, machine, character etc.

It is the object of the invention to provide for a system which uses the artificial intelligence mechanism in the best way to produce a augmented reality based creature in order to help the user communicate in the most effective manner.

These and other features, objects and advantages of the present invention will be readily apparent to persons of ordinary skill in the art upon reading the entirety of this disclosure, which includes the accompanying drawings and claims.

### BRIEF DESCRIPTION OF THE SEVERAL VIEWS OF THE DRAWING

FIG. 1 shows a flow chart representing operation of the system.

FIG. 2 shows a working view of the system.

### DETAILED DESCRIPTION OF THE INVENTION

In the present disclosure, numerous specific details are provided, such as examples of module, components, and method, to provide a thorough understanding of embodiments of the invention. Persons of ordinary skill in the art will recognize, however, that the invention can be practiced without one or more of the specific details. In other instances, well-known details are not shown.

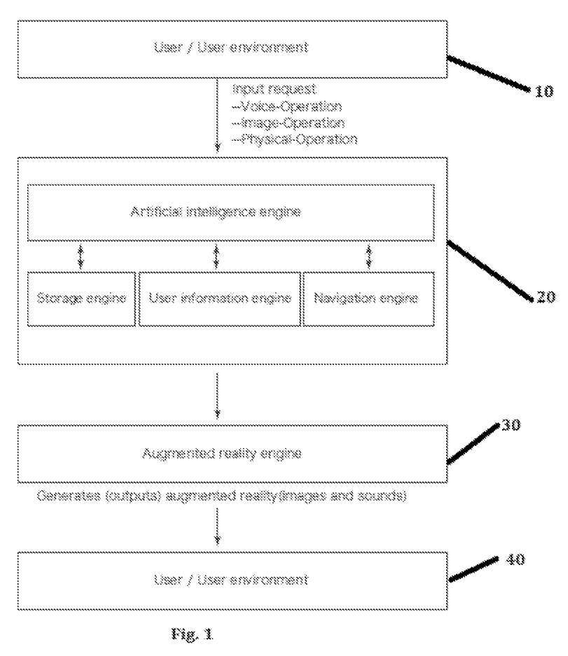

FIG. 1 shows a flow chart representing the general working of the current invention. In the flow chart it can be seen that user environment 10 is shown. The user has the option of providing certain requests to the device. The client device is capable of taking input requests in multiple formats. The input maybe in the form of voice operation, image operation or physical operation. The client device is equipped with certain equipments which is capable of taking such inputs. A microphone maybe installed to take voice input and similarly imaging devices may be added to obtain image input.

The client device send the input to the artificial intelligence engine 20 where the data received from the user environment is processed and output is produced. The data may be processed through a web browser which use the internet to process the data, alternatively this process may work without an internet connection where the data is processed through a local storage device. The artificial intelligence engine then processes the data based on an online platform or a local storage unit. The artificial intelligence engine uses the user information and produces output. The artificial intelligence engine also works out the navigation information as requested by the user. This may be done through the help of available data bases. This system also learns the habits of the user and keeps gradually improving as the user mode and style of operation.

Each conversation between the user and the creature is stored in the system and certain cues are taken from it regarding user behavior and preferences. The hobby of the user, the preferences of the user, the inclinations of the user for particular tasks is recorded the artificial intelligence engine keeps training the virtual creature for better use. The response given by the creature keeps on changing as per the new facts which it learns about the user. The artificial intelligence engine keeps the creature updated.

The artificial intelligence engine may also add life like features to the character and provide it with a certain life span just like organic life. The artificial intelligence engine may also allow the creature to communicate in such a manner that an emotional bond is established between the user and the creature. The character may also be trained to give responses in tandem to the age group of the user or the personality type of the user. The learning process of the creature continues for its life time and it continues to evolve by learning new characteristics of the user. The task of developing and nurturing the character is solely the responsibility of the artificial intelligence engine for which it may use methods as mentioned above or may incorporate new methods to give a brain of its own to the character.

The artificial intelligence engine then produces data which becomes input data for the augmented reality engine 30. The augmented reality engine produces output which is shown to the user. The user is equipped with devices to receive such kind of output. The output produced is such that an environment is created for the user to receive the output in proper manner.

The output produced by the augmented reality engine is delivered to the user through a character of user's choice. The user may choose any character to interact with ranging from a humanoid, pet, machine character, movie character etc. The user can very well interact with virtual creature and seek clarification regarding the results of his query generated.

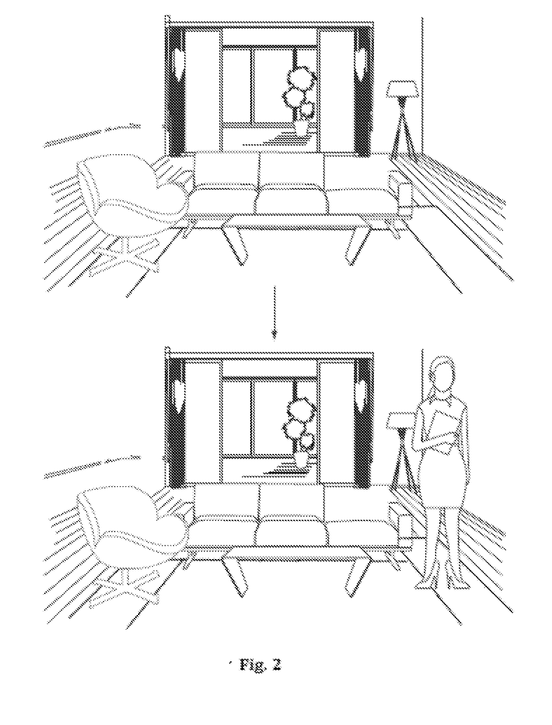

In FIG. 2 an user environment is shown where the augmented reality engine generates a virtual creature of user's choice. A lady is seen in the later image which is the character of choice of the user.

The system is capable of assisting the user in multiple kind of operations ranging from navigation to office work. The system may also be used as an office creature which provides help in daily operations.

While specific embodiments of the present invention have been provided, it is to be understood that these embodiments are for illustration purposes and not limiting. Many additional embodiments will be apparent to persons of ordinary skill in the art reading this disclosure.

What is claimed for is:

1. An system and method which has the capability of providing a virtual creature through the use of augmented reality and artificial intelligence.

2. The system and method in claim 1 comprising of:
a client device responsible for taking user inputs in for of queries;
an artificial intelligence engine which produces results for such queries and deliver it to the user through augmented reality engine;
an augmented reality engine which uses the data from artificial intelligence engine to produce a virtual creature of user's choice to deliver the results of the user's query.

3. The system and method in claim 1 may be used in various kinds of navigation systems.

4. The system and method in claim 1 having the capability of providing a system which helps the user in daily tasks like gathering information and taking specified help.

5. The system and method in claim 1 having the capability of nurturing the creature in order to continuously learn about the user and evolve for better use.
